(19) United States
(12) Patent Application Publication
(10) Pub. No.: US 2022/0198470 A1
(43) Pub. Date: Jun. 23, 2022

(54) Fraud Detection with a Stacked Auto Encoder with Embedding

(71) Applicant: Bottomline Technologies Ltd., Or Yehuda (IL)

(72) Inventors: Valerie Melul, Tel Aviv (IL); Avital Seraty, Ramat Hasharon (IL)

(73) Assignee: Bottomline Technologies Ltd., Or Yehuda (IL)

(21) Appl. No.: 17/132,540

(22) Filed: Dec. 23, 2020

(51) Int. Cl. G06Q 30/00; G06N 3/04; G06N 3/08; G06Q 40/02; G06Q 20/40; G06Q 40/00

(52) U.S. Cl. CPC G06Q 30/0185; G06N 3/0454; G06Q 40/12; G06Q 40/02; G06Q 20/4016; G06N 3/088

(57) ABSTRACT

An improved apparatus and method for detecting fraud is described using a stacked auto encoder with embedding to encode and decode a transaction to determine fraud. The technique includes model tuning software and transaction review software. The model tuning software views the transaction and tunes an artificial neural network model to minimize reconstruction loss. The transaction review software processes the transaction through the artificial neural network model, converting the transaction into a feature vector, encoding the feature vector into a compressed vector, decoding the compressed vector into a reconstructed vector, subtracting the reconstructed vector from the feature vector, and determining a fraud indication and reasoning based on a difference from the reconstructed vector from the feature vector.

### BACKGROUND

### Prior Application

This application is a priority application.

### Technical Field

The present inventions relate to machine learning and artificial intelligence and, more particularly, to a method and system for improving fraud detection using a stacked auto encoder with embedding.

### Description of the Related Art

The earliest history of fraud is found in the Greek literature, and history includes numerous schemes and tactics from taking money from others using deceptive means. One article in Forbes Magazine set the amount of money lost to fraud at $190 billion per year in 2009, with banks absorbing $11 Billion, consumers taking a $4.8 billion hit, and merchants absorbing the rest. The sheer magnitude of the money lost to fraud has forced banks and payment services to place an increasing emphasis on fraud detection.

Today, payment fraud is a sophisticated global business. Cybercriminals are organized, coordinated, and highly specialized, thus creating a powerful network that is, in many ways, a significantly more efficient ecosystem than the banking industry. They continually reinvest their financial gains to advance technology and methods used to defeat the layers of security financial institutions put in place.

The pace of fraud innovation by fraudsters and their ability to invest in attacking banks and payment vendors far outweigh these institutions abilities to invest in protecting themselves against rapidly evolving threats. Whether it's phishing scams, mobile malware, banking Trojans, Man-In-the-Browser schemes, or the many techniques for bypassing multi-factor authentication, threats span online banking, mobile banking, as well as the ACH and wire payments channels. The range and sophistication of the threats against which financial institutions must defend themselves continue to grow.

The traditional approach to fraudulent activities is to manually analyze historical payment transactions looking for patterns or for transactions that are out of line with the norm. But these methods fail to prevent fraudulent activities, instead, they only serve to disclose what happened in the past. And the sheer volume of transactions prevents the review of more than a small sampling of the overall transaction set.

There is a long-felt need to efficiently and automatically review and identify potentially fraudulent transactions in real-time as the transactions cross the payment rail. The present inventions overcome this shortcoming of the existing art with improved fraud detection by using a stacked auto encoder with embedding.

### SUMMARY OF THE INVENTIONS

An improved apparatus for detecting fraud is described here. The improved apparatus is made up of a rail transceiver, memory, and a processor connected to the rail transceiver and the memory. The processor operates model tuning software and transaction review software. The processor receives a transaction from the rail transceiver and stores the transaction in the memory. The model tuning software views the transaction in the memory and tunes an artificial neural network model with the transaction. The transaction review software processes the transaction through the artificial neural network model, converts the transaction into a feature vector, encodes the feature vector into a compressed vector, decodes the compressed vector into a reconstructed vector, subtracts the reconstructed vector from the feature vector, and determines a fraud indication based on a difference from the reconstructed vector from the feature vector.

The transaction review software could determine a reasoning for the fraud indication. The transaction review software could instruct the processor to send a message through the rail transceiver to a fraud monitor. The transaction review software could instruct the processor to send a message through the rail transceiver to a bank. The transaction review software could instruct the processor to block the transaction if the transaction is determined to be fraudulent. The model tuning software could tune the artificial neural network model to minimize the difference between the feature vector and the reconstructed vector. The artificial neural network model could be a stacked artificial neural network model. The rail transceiver could be connected to a payment rail. The rail transceiver could be a promiscuous transceiver. The processor could be a cluster of graphical processing units.

An improved method for detecting fraud is also described here. The improved method comprises (1) receiving a transaction, (2) parsing the transaction into a feature vector, (3) encoding the feature vector through a first artificial neural network to compress the feature vector into a compressed vector, (4) decoding the compressed vector through a second artificial neural network into a reconstructed vector, (5) subtracting the reconstructed vector from the feature vector into a difference vector, and (6) analyzing the difference vector for a fraud indication.

The improved method could further comprise (7a) parsing the difference vector for reasons for the fraud indication The improved method could further comprise (7b) sending a notification to a fraud monitor of the fraud indication. The improved method could further comprise (7c) sending a notification to a bank of the fraud indication. The improved method could further comprise (7d) blocking the transaction if fraud is indicated. The improved method could further comprise (7e) tuning the first artificial neural network and the second artificial neural network to minimize the difference between the feature vector and the reconstructed vector.

The first artificial neural network could be a stacked artificial neural network. The first artificial neural network could comprise a plurality of layers. The transaction could be received from a payment rail. The transaction could be received from accounting software.

### BRIEF DESCRIPTION OF THE DRAWINGS

FIG. 1 is a block diagram of the components of the present system.

FIG. 2 is a diagram of information flow through the auto encoder.

FIG. 3 is a formula showing the subtraction of features.

FIG. 4 is a diagram of the equipment used in one embodiment.

FIG. 5 is a flowchart of the operation of the stacked autoencoders.

### DETAILED DESCRIPTION

The present inventions are now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer-readable media accessible to the processor, or a combination of a hardware circuit(s) and a processor or control block of an integrated circuit executing machine-readable code encoded within a computer-readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer-readable media, or a combination of a hardware circuit(s) and a processor and/or control block executing such code.

An auto encoder is a type of artificial neural network used to learn efficient data codings in an unsupervised manner. The aim of an auto encoder is to learn a representation (encoding) for a set of data, typically for dimensionality reduction, by training the network to ignore signal “noise”. Along with the reduction side, a reconstructing side is learned, where the autoencoder tries to generate from the reduced encoding a representation as close as possible to its original input, hence its name. An auto encoder is a neural network that learns to copy its input to its output. It has an internal (hidden) layer that describes a code used to represent the input, and it is constituted by two main parts: an encoder that maps the input into the code, and a decoder that maps the code to a reconstruction of the original input. A Deep Neural Network Encoder-Decoder architecture aims at learning how to compress information in order to reduce reconstruction loss.

The neural network trains to perform the copying task perfectly, duplicating the signal within a confidence score. Auto encoders usually are restricted in ways that force them to reconstruct the input approximately, preserving only the most relevant aspects of the data in the copy. However, when used to auto encode payment transactions, a fraudulent transaction will not reconstruct properly. Thus, when comparing the input transaction to the reconstructed transaction, the confidence score (the difference between the two) will be greater than normal, allowing the machine to create a fraud alert.

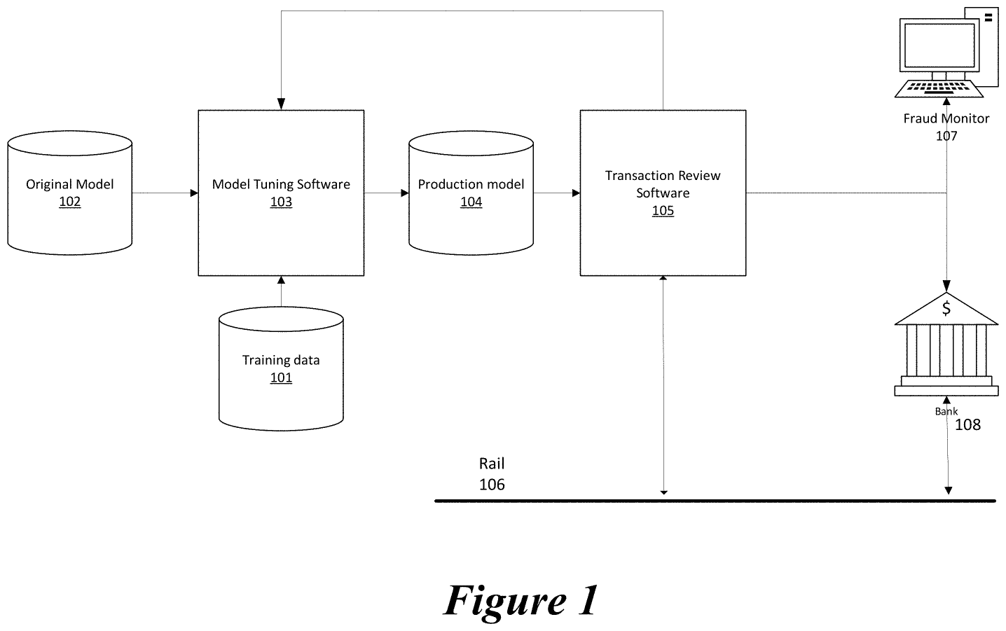

Looking at FIG. 1, a system diagram is presented showing the fraud monitoring environment. A database holding the training data 101 contains transaction records that are used for the initial training of the original neural network model 102. In some embodiments, each transaction seen on the rail 106 is added to the training data 101, cleared either through another process in the system or through the transaction review software 105, and routed from the fraud monitor after investigation. In other embodiments, once the artificial neural network model is generated, transactions seen on the rail 106 are used to tune the production model, but are not saved. In some cases, the transactions are batched up in the training data 101, and the production model 104 is re-tuned 103 periodically. In other cases, the tuning 103 is done as each transaction is received. See FIG. 1 and its corresponding description in U.S. patent application Ser. No. 16/985,773, “Fraud Detection Rule Optimization”, filed Aug. 5, 2020, by Dalit Amitai, Shahar Cohen, Yulia Mayer, and Avital Serfaty, incorporated herein in its entirety by reference.

The tuning software 103 modifies the neural network in the auto encoder by evaluating and incrementally minimizing the difference between the reconstructed transaction and the original input transaction, adjusting the encoder and the decoder to create a better match based on the reasons for the deviances on the transaction. The model tuning software 103 outputs a production model 104 that is tuned by the latest transaction received from the rail 106.

In order to avoid too many false alerts and yet not to miss frauds, the features are first compressed separately into entity embeddings. Then the compressed transaction record is computed from these embeddings (compressed features).

At the reconstruction phase, the compressed transaction is first expanded into some reconstructed embeddings. The original features are then computed from the reconstructed embeddings. This process ensures both scalability and precision. Scalability because of the divide and conquer approach enabled by the embeddings. Precision because the loss function by which the artificial neural network tuning will take place can be optimized depending on the nature of each feature. The feature-specific initialization process of the artificial neural network weights moreover speeds the convergence of the process. Finally, another advantage of this architecture is that separately compressing the features while training the whole auto-encoder structures enables us to reach an efficient embedding compression state for the unlabeled target of recovering the original transaction.

Alternatively, the tuning software 103 can modify the artificial neural network in the auto-encoder on performance degradation or periodically.

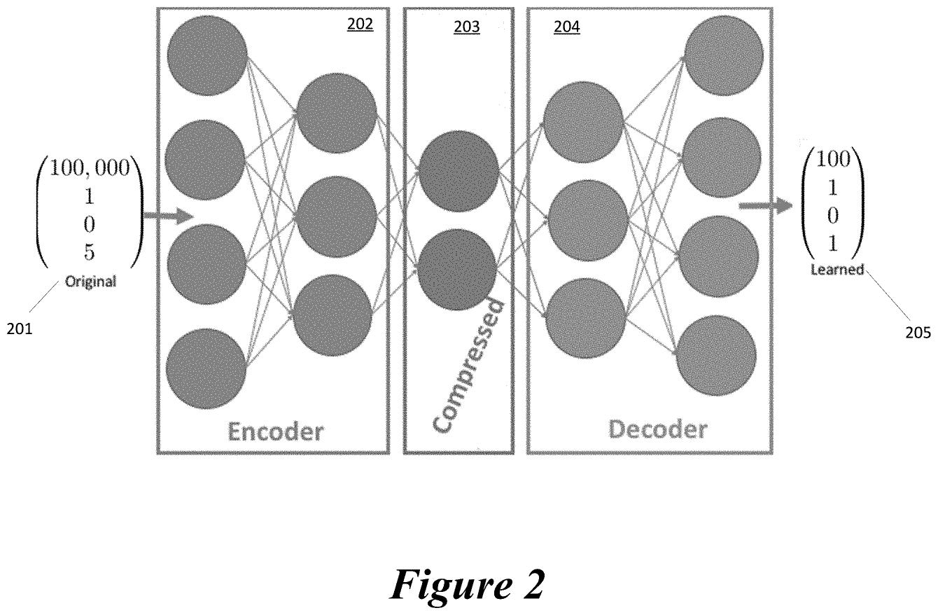

The production model 104 is a neural network configured as an auto encoder that may indicate fraudulent behavior when applied to a transaction. The production model 104, in each dimension, may look similar to FIG. 2. The production model 104 is used by the transaction review software 105 to analyze each transaction seen on the rail 106.

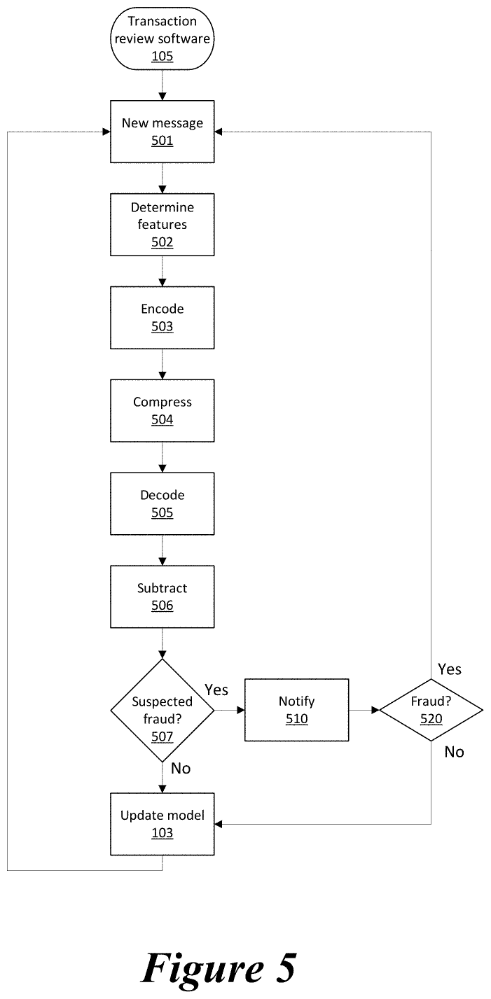

The transaction review software 105, in some embodiments, listens to the transactions on the rail 106 in promiscuous listener mode, retrieving all transactions that cross the rail 106. When a transaction is seen, it is analyzed to determine and enrich its features and sent through the transaction review software 105, which uses the production model 104, to determine if the transaction is fraudulent. The details of the transaction review software 105 are found below in conjunction with the discussion of FIG. 5. In another embodiment, a bank, a financial institution, or another software package could collect the transactions and send them to the transaction review software 105, following feature processing and enrichment. For instance, a bank 108 may run banking software that processes each transaction that the bank 108 receives on the rail 106. The banking software may send each transaction to the transaction review software 105 before processing the transaction to see if the transaction is fraudulent.

The rail 106 is a payment or banking rail used to connect banks, financial institutions, or their customers. It is a high-security network that uses encryption and limits access either physically or virtually (VPN). The physical implementation of the rail 106 could be the internet, a local area network, a wireless network, a combination of the above, or any other networking technology.

If the transaction monitoring software 105 determines that a transaction is fraudulent, then the transaction monitoring software, in some embodiments, notifies the bank 108 (or financial institution or the customer) to hold the transaction. A notification is also sent to the fraud monitor 107 for investigation by the fraud investigation team. The fraud investigation team then will review the transaction and the reasons that the transaction monitoring software 105 thought the transaction to be fraudulent to decide on whether to cancel the transaction. The fraud investigation team will also mark the transaction as actual fraud, false-positive, or justified. A justified determination is when the transaction appears fraudulent and is not a fraud, but the fraud investigation team still wants to review this type of transaction. When tuning in the future, the justified transactions are considered fraudulent.

The fraud monitor 107 could be a personal computer, laptop, smartphone, tablet, smartwatch, or similar device connected directly or indirectly through a network to the transaction monitoring software 105. The fraud monitor 107 has the interface between the transaction monitoring software and the fraud investigation team.

FIG. 2 shows a diagram of information flow through the auto encoder. The features from the transaction are parsed into an encoding of features for the aspects of the transaction. In some embodiments, one-hot encoding of the data is used to represent aspects of the transaction. In machine learning, a one-hot is a group of bits among which the legal combinations of values are only those with a single high (1) bit and all the others low (0). For instance, a one-hot encoding of the day of the week would be 0000100 for Thursday, and 0100000 for Monday. Using one-hot encoding allows for a very large set of features to represent each transaction.

In the example in FIG. 2, we simplify the features significantly in order to represent the complex networks on paper. The four input features 201 represent $100,000 US Dollars (100,000), a company called “Clean Place Ltd” as customer 1, Monday as day 0, and the destination country Ukraine represented as 5. The four input features 201 are sent to encoder that will reduce the four features into three features 202. The features are then compressed 203 into two features 202. Once the features have been compressed 203, they are decoded 204 into three and then four features. Through this encoding and decoding, the features are transformed to $100 US dollars, “Clean Place Ltd” as customer 1, Monday as day 0, and the destination country Italy represented as 1. This essentially is showing that the neural network has been trained to expect Clean Place Ltd to pay a $100 to Italy each Monday. But this example is showing a different country and a significantly larger transaction size, possibly indicating fraud.

An autoencoder is a kind of unsupervised learning structure that owns three layers: input layer, hidden layer, and output layer as shown in FIG. 2. The process of an autoencoder training consists of two parts: encoder 202 and decoder 204. Encoder 202 is used for mapping the input data 201 into hidden compressed representation 203, and decoder 204 is referred to reconstructing input data 201 from the hidden compressed representation 203 into the reconstructed data 205.

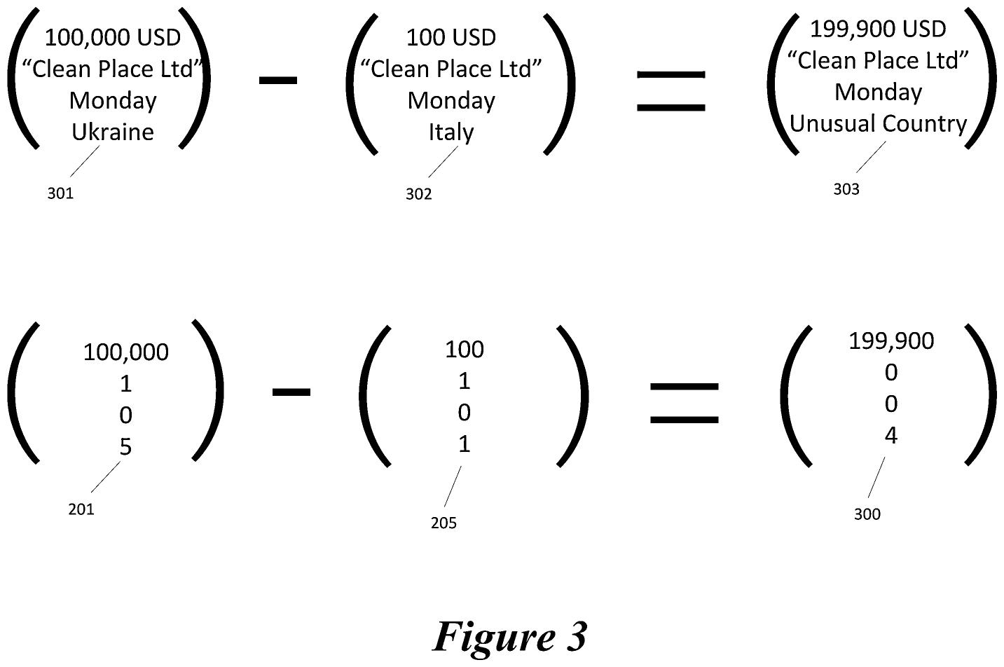

FIG. 3 shows a formula subtracting the input features 201, 301 from the output features 205, 302. The subtraction results in the feature set 300, 303 showing a suspicious transaction. The text meaning of the feature values is shown in 301, 302, and 303. One possible numeric representation of the features is shown in 201,202, 300. The subtraction in this example shows that the amount is $99,900 more than typical, and the country is unusual.

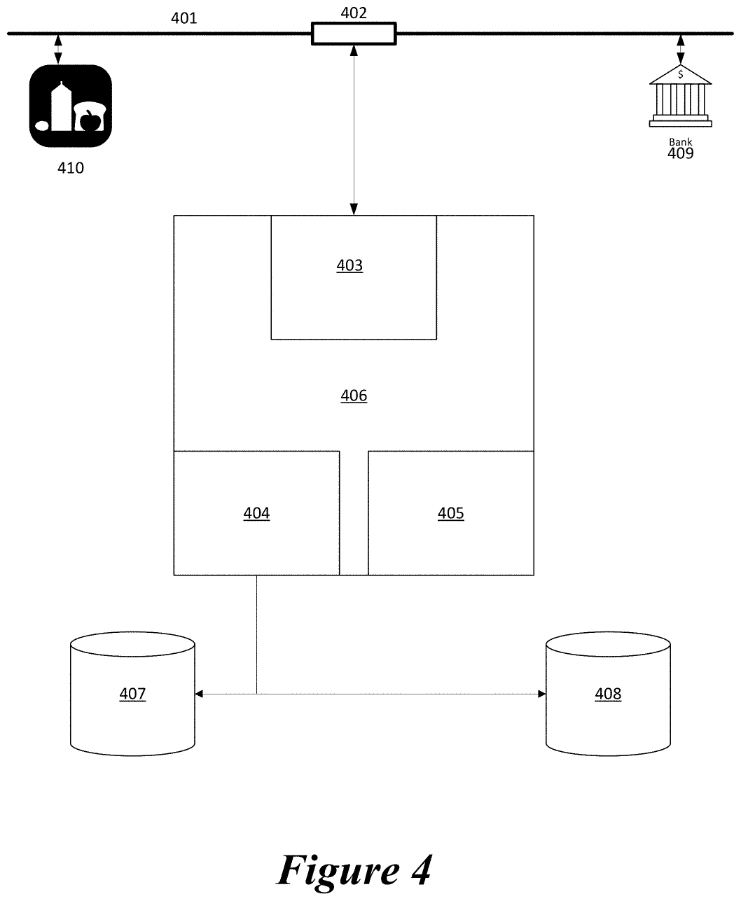

FIG. 4 shows one possible physical embodiment of the fraud monitoring system. The rail 401 (see also 106) is a network, such as the Ethernet (IEEE 802.3), Wi-Fi (IEEE 802.11), token ring, fiber optic, cellular in the form of a local area network, a wireless network, a wide area network or similar. The rail 401 in this embodiment has a tap 402 allowing the transaction review device 406 to access the rail 401. The rail 401 could be a payment network, a banking network, a financial transaction network, etc.

The rail 401 is connected to a merchant 410 and to a bank 409. In a typical embodiment, there would be numerous merchants and could be a number of banks as well. The merchant 410 would send a payment transaction message to the bank 409 over the rail 401, instructing that a payment be made. The transaction review device 406 listens to the rail 401 and sees the transaction, and determines if it is fraudulent. If so, the transaction review device 406 sends the bank 409 a message over the rail 401 stopping the transaction.

The tap 402 connects to a promiscuous transceiver 403, a wired or wireless receiver/transmitter that is configured to receive all rail 401 traffic.

The transaction review device 406 includes a promiscuous transceiver 403, in some embodiments, one or a cluster of central processing units and/or graphical processing units 404 for processing the transactions through the auto encoder and for operating a promiscuous network stack. In some embodiments, the network stack could address only messages addressed to this device. This central processing unit 404 could be a high performance, multi-core device for handling the volume of transactions. In some embodiments, the central processing unit 404 could be a combination of ASICs for processing the network stacks and ASICs for high-performance operation of the auto encoding neural networks. A microprocessor may also be part of this ASIC combination to manage the processing. The transaction review device 406 also includes memory 405 for storing the data while processing. In this embodiment, the rail transceiver 403, the central processing unit 404, and the memory 405 are mechanically and electrically connected within the transaction review device 406. The transaction review device 406 runs the transaction review software 105, and in some embodiments also runs the model tuning software 103.

The transaction review device 406 is connected, electrically, optically, or wirelessly, to the original model store 407 and to the training data store 408. The original model store 407 could contain both the training data 101 and the production model 104 in some embodiments. The training data 101 is stored in the training data store 408. In some embodiments, the training data store 408 and the original model store 407 could be the same physical device. Both data stores 407, 408 could be a magnetic hard drive, an optical drive, a solid-state drive, a RAM, or a similar data storage device.

Looking at FIG. 5, we see the transaction review software 105 from FIG. 1 further expanded. The transaction review software 105 could be configured as software-as-a-service, receiving transactions for review before forwarding to a banking institution. Alternatively, the transaction review software 105 could be a local routine accessed by accounting software or payments software. In still another embodiment, the transaction review software 105 could hang on the rail 106 and review all transactions seen on the rail 106. In another embodiment, the transaction review software 105 is part of receivables software checking for suspicious payments received. Or the transaction review software 105 could be integrated into banking software.

The process starts by obtaining a new transaction 501. The message could be received from the banking or payment rail 106 directly using promiscuous listener mode on a rail transceiver to collect all transactions on the rail 106. Alternatively, the message could be specifically directed, possibly from a payments-as-a-service software application, to the transaction monitoring software 105 for analysis before the transaction monitoring software 105 forwards the non-fraud transactions to the banking rail 106. In still another embodiment, the transaction comes from payments software or accounts payable software and is reviewed before placing it on the payment transaction on the rail 106.

Once a transaction is received 501, the transaction is parsed into an array of features 502. In some embodiments, this is a sparse array, with many items converted into one-hot encoding. A simple date code, 12182020 071036, may be converted into a one-hot field for the month (000000000001), day of the week (Friday, 0000010), year, and day of the month may be left as integers or converted to a one-hot encoding. The time zone could be determined and set into a one-hot field. The hours, seconds, and minutes could also be encoded either as integers or as one-hot values. The date and time could be converted into a contiguous count of the number of seconds since a fixed point in time, and this value stored. The value of the transaction could be set with one-hot fields for the type of currency (US dollars, Euros, Yen, etc), and integer for the value of the currency, a one-hot encoding of the range of value (0-10, 10-100. 100-1000, 1000-10000, 10000-100000, etc.), and perhaps a value of the transaction in a common currency.

The feature set is next encoded 503 using neural network techniques. Some embodiments use a single layer neural network, other embodiments use two or more layers (two or more hidden layers).

The formula for determining a hidden vector 202, 203, hₙ from the input data 201 (feature vector) is:

hₙ=fₙ(Wₙxₙ+bₙ)

Where n is the index of the hidden layers, hₙ is the hidden compressed vector 202, 203, fₙ is an activation function, Wₙ is the weight matrix of the encoder, xₙ is the input feature vector 201, 202 and bₙ is the bias vector.

The encoder 503 produces a hidden compressed vector 203, 504 that contains a smaller number of features than the input feature vector 201. The decoder 505 then reverses this process, attempting to recreate the input feature vector 201 from the compressed vector 203, creating the reconstructed vector 205, \hat{x}ₙ below.

The decoder 505 process is defined as:

\hat{x}ₙ=gₙ(W′ₙhₙ+b′ₙ)

Where \hat{x}ₙ is the output, reconstructed vector 205 of the input vector 201, g is the decoding function, W′ₙ is the weight matrix of the decoder, hₙ is the hidden compressed vector 203, as calculated above, and b′ₙ is the bias vector.

Once the reconstructed vector 205 is created, the reconstructed vector 205 is subtracted 506 from the input vector 201 to create the difference vector 303. The difference vector is summed to create a confidence score. In some embodiments, the difference vector is multiplied by a predetermined weight vector to balance the impact of the features on the confidence score.

The subtraction 506 also provides the reasoning for the confidence score. As is seen in FIG. 3, the subtraction sees no difference in the difference vector 303 for the company name “Clean Place Ltd” not in the day “Monday”. But the country and the transaction amount are very different, and are visible as the reason for the confidence score.

Next, the confidence score is checked for suspected fraud 507 by comparing the confidence score to a constant threshold. The comparison shows a fraud indication regarding the message. In some embodiments, the constant threshold is adjusted through machine learning techniques.

If fraud is determined, then the fraud monitors 107 are notified 510. In addition to sending the fraud monitors 107 the notification of fraud, the transaction itself and reasoning for the confidence score is provided, so that the fraud monitors can easily see the reason fraud was determined.

The fraud monitors 107 then make the determination if this is true fraud and take steps to prevent the completion of the fraudulent transaction. In addition, the fraud monitors make determine whether the machine's determination is justified or not. In some instances, a suspicious transaction is flagged as fraudulent, but is not actual fraud, but is suspicious enough that the machine is taught to continue flagging such transactions as fraud. True fraudulent transactions and justified transactions are not used to update the model.

If the transaction is not fraud 520, either as determined by the model or by the fraud monitors 107, then the model is updated to minimize the reconstruction loss by the model tuning software 103.

Although the inventions are shown and described with respect to certain exemplary embodiments, it is obvious that equivalents and modifications will occur to others skilled in the art upon the reading and understanding of the specification. It is envisioned that after reading and understanding the present inventions those skilled in the art may envision other processing states, events, and processing steps to further the objectives of the system of the present inventions. The present inventions include all such equivalents and modifications, and is limited only by the scope of the following claims.

1. An improved apparatus for detecting fraud, the improved apparatus comprising:
a rail transceiver;
memory;
a processor connected to the rail transceiver and the memory, wherein the processor operates model tuning software and transaction review software;
the processor receives a transaction from the rail transceiver and stores the transaction in the memory;
the model tuning software views the transaction in the memory and tunes an artificial neural network model with the transaction; and
the transaction review software processes the transaction through the artificial neural network model, converts the transaction into a feature vector, encodes the feature vector into a compressed vector, decodes the compressed vector into a reconstructed vector, subtracts the reconstructed vector from the feature vector, and determines a fraud indication based on a difference from the reconstructed vector from the feature vector.

2. The improved apparatus of claim 1 wherein the transaction review software determines a reasoning for the fraud indication.

3. The improved apparatus of claim 1 wherein the transaction review software instructs the processor to send a message through the rail transceiver to a fraud monitor.

4. The improved apparatus of claim 1 wherein the transaction review software instructs the processor to send a message through the rail transceiver to a bank.

5. The improved apparatus of claim 1 wherein the transaction review software instructs the processor to block the transaction if the transaction is determined to be fraudulent.

6. The improved apparatus of claim 1 wherein the model tuning software tunes the artificial neural network model to minimize the difference between the feature vector and the reconstructed vector.

7. The improved apparatus of claim 1 wherein the artificial neural network model is a stacked artificial neural network model.

8. The improved apparatus of claim 1 wherein the rail transceiver is connected to a payment rail.

9. The improved apparatus of claim 1 wherein the rail transceiver is a promiscuous transceiver.

10. The improved apparatus of claim 1 wherein the processor is a cluster of graphical processing units.

11. An improved method for detecting fraud, the improved method comprising:
receiving a transaction;
parsing the transaction into a feature vector;
encoding the feature vector through a first artificial neural network to compress the feature vector into a compressed vector;
decoding the compressed vector through a second artificial neural network into a reconstructed vector;
subtracting the reconstructed vector from the feature vector into a difference vector; and
analyzing the difference vector for a fraud indication.

12. The improved method of claim 11 further comprising parsing the difference vector for reasons for the fraud indication.

13. The improved method of claim 11 further comprising sending a notification to a fraud monitor of the fraud indication.

14. The improved method of claim 11 further comprising sending a notification to a bank of the fraud indication.

15. The improved method of claim 11 further comprising blocking the transaction if fraud is indicated.

16. The improved method of claim 11 further comprising tuning the first artificial neural network and the second artificial neural network to minimize a difference between the feature vector and the reconstructed vector.

17. The improved method of claim 11 wherein the first artificial neural network is a stacked artificial neural network.

18. The improved method of claim 11 wherein the first artificial neural network comprises a plurality of layers.

19. The improved method of claim 11 wherein the transaction is received from a payment rail.

20. The improved method of claim 11 wherein the transaction is received from accounting software.
